(19) United States
(12) Patent Application Publication
(10) Pub. No.: US 2015/0246393 A1
(43) Pub. Date: Sep. 3, 2015

(54) METHOD OF MANUFACTURING CONNECTING ROD BY USING SEMI-CLOSED SINTER FORGING

(71) Applicant: Hyundai Motor Company, Seoul (KR)

(72) Inventors: Hak-Soo Kim, Buchun (KR); Boo-Yong Jung, Busan (KR)

(21) Appl. No.: 14/556,105

(22) Filed: Nov. 29, 2014

(30) Foreign Application Priority Data
Mar. 3, 2014 (KR) 10-2014-25174

(51) Int. Cl. B22F 5/00; F02F 3/00; B22F 3/24; B22F 3/12; B22F 3/17

(52) U.S. Cl. CPC B22F 5/00; B22F 3/12; B22F 3/17; B22F 3/24; F02F 3/0015; B22F 2003/248; B22F 2003/247

(57) ABSTRACT

Disclosed is a method of manufacturing a connecting rod by using semi-closed sinter forging. The method includes: a first step of positioning a metal powder of a sintering material in a closed mold and then forming a preliminary formed body by using a general forming press; a second step of heating the formed preliminary formed body to sinter the preliminary formed body; a third step of semi-closed forging the sintered preliminary formed body to manufacture a forged part; a fourth step of cooling the manufactured forged part to normal temperature; a fifth step of removing a flash from the cooled forged part through a punching process; and a sixth step of manufacturing the connecting rod through a shot blast treatment in order to remove a foreign substance existing on a surface of the forged part from which the flash is removed.

### CROSS-REFERENCE TO RELATED APPLICATIONS

This application claims priority under 35 U.S.C. §119 to Korean Patent Application No. 10-2014-25174, filed on Mar. 3, 2014, in the Korean Intellectual Property Office, the disclosure of which is incorporated herein by reference in its entirety.

### TECHNICAL FIELD

The present invention relates to a method of manufacturing a connecting rod for connecting a piston of a vehicle engine and a crankshaft pin. Particularly, the method of manufacturing a connecting rod may provide improved yield strength, tensile strength, and the like by using semi-closed sinter forging including a step of forming a preliminary formed body, a sintering step, a forging step, and the like.

### BACKGROUND

A vehicle production technology has been continuously developed to thereby achieve many objects which satisfying diversification of current demands of customers, high performance and quality. Furthermore, manufacturing cost has been significantly reduced through prime cost reduction due to competition and supply expansion, as well as mass production.

Particularly, a research for developing a connecting rod, which is a part serving an important role of transferring kinetic energy of a piston through a crankshaft to a wheel, has been conducted, and thus the connecting rod has been obtained with improved yield strength, tensile strength, and the like while reducing production cost.

In a vehicle, the connecting rod refers a rod for connecting a piston pin and a crank pin and is also called as a con-rod. In the connecting rod, a portion connected to the piston pin is a small end portion, and a portion connected to the crank pin is a big end portion. Further, an I end portion having an I-shaped cross-section which connects the small end portion and the big end portion is a portion requiring excellent mechanical properties such as a tensile load and a compressive load.

In particular, an explosion pressure formed in a cylinder applies a large compressive load through a piston head in a longitudinal direction to the connecting rod. Further, since a motion of the piston is alternately performed, continuous force may be applied in tensile load and compressive load may be formed in the longitudinal direction of the connecting rod, and thus bending and the like may occur.

A method of manufacturing the connecting rod to improve mechanical properties such as tensile strength and compressive strength may include a hot forging process or a sinter forging process. However, since a metal flow is formed in the connecting rod manufactured by the hot forging process, mechanical strength may be improved, but many wasted flashes and the like may be generated and manufacturing cost may increase due to a number of forging processes.

The connecting rod manufactured by the sinter forging process has advantages in that manufacturing cost may be reduced, a loss amount of materials may be significantly reduced because a flash is not formed during a process. Moreover, heat treatment and the like for removing residual stress may not be required as compared to the connecting rod manufactured by applying the hot forging process. However, since the metal flow is not formed therein, mechanical properties may deteriorate.

The above information disclosed in this Background section is only for enhancement of understanding of the background of the invention and therefore it may contain information that does not form the prior art that is already known in this country to a person of ordinary skill in the art.

### SUMMARY OF THE INVENTION

Now we provide a method of manufacturing a connecting rod having improved yield strength and tensile strength and the like by setting an optimum manufacturing step to provide technical solutions to above mentions problems in the art.

In an exemplary embodiment, a method of manufacturing a connecting rod by using semi-closed sinter forging, may include steps of: a first step of positioning a metal powder of a sintering material in a closed mold and then forming a preliminary formed body by using a general forming press; a second step of heating the formed preliminary formed body to sinter the preliminary formed body; a third step of semi-closed forging the sintered preliminary formed body to manufacture a forged part; a fourth step of cooling the manufactured forged part to normal temperature; a fifth step of removing a flash from the cooled forged part through a punching process; and a sixth step of manufacturing the connecting rod through a shot blast treatment in order to remove a foreign substance existing on a surface of the forged part from which the flash is removed.

In certain exemplary embodiments, in the second step, a sintering temperature may be in a range of about 1100 to about 1250° C., and a present sintering time may be about 10 to 30 minutes at the sintering temperature.

In yet certain exemplary embodiments, in the second step, an atmosphere during sintering may include nitrogen gas (N₂) and hydrogen gas (H₂), and a volume ratio of nitrogen gas (N₂) and hydrogen gas (H₂) may be about 90:10.

In still certain exemplary embodiment, in the third step, an average thickness of the flash formed around the forged part may be in a range of about 0.3 to about 0.5 mm.

In certain exemplary embodiments, in the fourth step, when the forged part that is subjected to forging is cooled to normal temperature, a cooling speed may be in a range of about 0.8 to about 1.2° C./s.

Particularly, during the short blast treatment of the sixth step, surface roughness of the forged part may be about 30 μm.

In other certain exemplary embodiments, that the preliminary formed body may be formed by using a forming mold having two punches at an upper end and three punches at a lower end.

In other aspect, a connecting rod for a vehicle may be manufactured by the method in various exemplary embodiments.

Other aspects of the invention are disclosed infra.

According to various exemplary embodiments of the present invention, manufacturing cost for the connecting rod may be reduced as compared to a hot forging process or a sinter forging process used in the related art. In addition, metal flow may be no greater than that of the connecting rod manufactured by using hot forging to obtain the connecting rod that is a final forged part. Accordingly, the manufactured connecting rod may have improved mechanical properties such as yield strength and tensile strength, and the like.

### BRIEF DESCRIPTION OF THE DRAWINGS

The above information disclosed in this Background section is only for enhancement of understanding of the background of the invention and therefore it may contain information that does not form the prior art that is already known in this country to a person of ordinary skill in the art.

FIG. 1 schematically illustrates an exemplary preliminary formed body having a shape and a size that are similar to those of a final product by using press forming of a sinter forging process according to an exemplary embodiment of the present invention.

FIG. 2 schematically illustrates an exemplary flash generated at an outskirt of a forged part according to an exemplary embodiment of the present invention.

FIG. 3 schematically illustrates an exemplary completed forged part according to an exemplary embodiment of the present invention.

FIG. 4 schematically illustrates an exemplary big end portion, an exemplary small end portion, and an exemplary I end portion connecting the big end portion and the small end portion of a connecting rod according to an exemplary embodiment of the present invention

FIG. 5 schematically illustrates a cross-section of the I end portion of an exemplary connecting rod obtained by forging the preliminary formed body through semi-closed forging using an upper mold and a lower mold according to an exemplary embodiment of the present invention.

FIG. 6 is a microscopic view illustrating a metal flow of an I cross-sectional portion of the connecting rod manufactured by using semi-closed sinter forging according to the present invention.

FIG. 7 is a microscopic view showing a metal flow of an I cross-sectional portion of a connecting rod manufactured by using hot forging in the related art.

FIG. 8 is a microscopic view of a microtissue of an exemplary connecting rod manufactured by using semi-closed sinter forging according to an exemplary embodiment of the present invention.

FIG. 9 is a microscopic view of a microtissue of a connecting rod manufactured by using hot forging in the related art.

FIG. 10 is a microscopic view of a microtissue of a connecting rod manufactured by using sinter forging in the related art.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner.

Hereinafter, the present invention will be described in detail with reference to drawings and the like.

In an aspect, the present invention relates to a method of manufacturing a connecting rod for improving strength and buckling properties. In particular, the method of manufacturing the connecting rod according to the present invention may include a semi-closed hot forging process in which advantages of a hot forging process and a sinter forging process in the related art may be provided together.

The hot forging process in the related art includes: a first forming step of a round bar steel material through a bluster process using semi-closed forging; a second forming step through a blocker process; a third forming step through a finisher process; a fourth forming step through a trimming process for removing a flash formed in the aforementioned procedure; and the like. The hot forging process may have advantages in that strength and the like of products may be improved.

The sinter forging process in the related art includes a step of positioning a metal powder of a sintering material in a closed mold and then forming a preliminary formed body by using a precise forming press, a step of forging the preliminary formed body by using closed forging, and the like. The sinter forging process may have advantages in that the degree of precision and the like of products are improved.

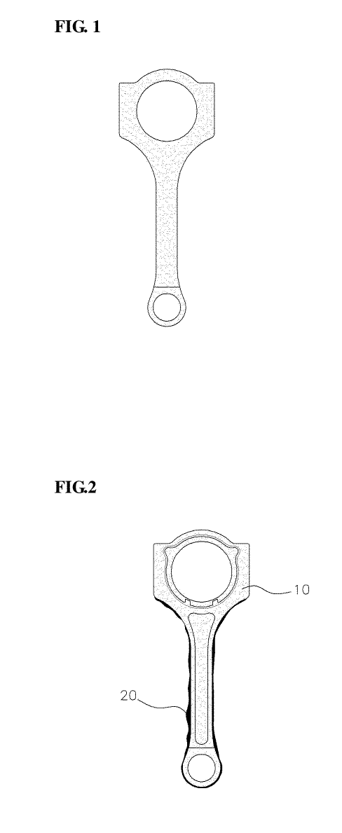

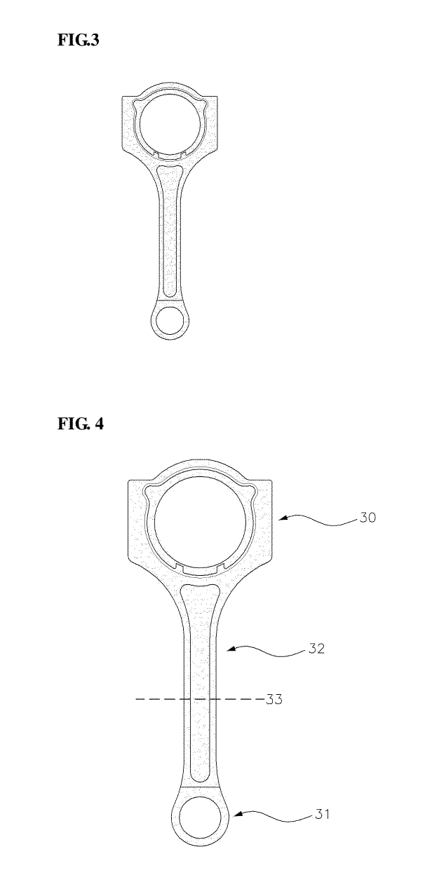

Accordingly, in the semi-closed hot forging process in an exemplary embodiment of the present invention, as illustrated in FIG. 1, a preliminary formed body having a shape and a size that are similar to those of a final product may be formed by using press forming of the sinter forging process. Subsequently, a flash 20 generated at an outskirt of a forged part 10 as illustrated in FIG. 2 by using semi-closed forging of the formed preliminary formed body may be removed, and then the forged part as illustrated in FIG. 3 may be manufactured.

Particularly, the method of manufacturing the connecting rod according to an exemplary embodiment of the present invention may include steps of: a first step of positioning a metal powder of a sintering material in a closed mold and then forming the preliminary formed body by using a general forming press; a second step of heating the formed preliminary formed body to sinter the preliminary formed body; a third step of semi-closed forging the sintered preliminary formed body to manufacture the forged part; a fourth step of cooling the manufactured forged part to normal temperature; a fifth step of removing the flash through a punching process of the cooled forged part; and a sixth step of manufacturing the connecting rod through a shot blast treatment in order to remove a foreign substance existing on a surface of the forged part from which the flash is removed.

In certain exemplary embodiments, a sintering temperature of the second step may be in a range of about 1100 to about 1250° C., or particularly of about 1120° C. When the sintering temperature is less than about 1100° C., the metal powders may not be sintered. When the sintering temperature is greater than about 1250° C., a sintering effect may not be obtained accordingly so that economic efficiency may be reduced, and the metal powder may be melted.

In yet certain exemplary embodiments, at the sintering temperature, a sintering time may be about 10 to 30 minutes. When the sintering time is less than about 10 minutes, the metal powder may not be sintered. When the sintering time is greater than about 30 minutes, the sintering effect may be not obtained accordingly so that economic efficiency may be reduced. In still certain exemplary embodiments, an atmosphere during sintering may include nitrogen gas (N₂) and hydrogen gas (H₂), and a volume ratio of nitrogen gas (N₂) and hydrogen gas (H₂) may be about 90:10.

In other certain exemplary embodiments, an average thickness of the flash 20 formed around the forged part 10 subjected to forging during semi-closed forging of the third step may be in a range of about 0.3 to about 0.5 mm. Particularly, a size of the flash 20 may have a thickness of about 1/10 of 5 mm which corresponds to the size of the flash formed by the hot forging process in the related art.

FIG. 4 schematically illustrates a big end portion 30, a small end portion 31, and an I end portion 32 connecting the big end portion 30 and the small end portion 31 of an exemplary connecting rod according to an exemplary embodiment of the present invention. FIG. 5 also schematically illustrates a cross-section 33 of the I end portion of an exemplary connecting rod obtained by forging the preliminary formed body through semi-closed forging using an upper mold 40 and a lower mold 41. As such, the flash 20 may be formed in a space between the upper mold 40 and the lower mold 41.

Particularly, since a volume of the mold in semi-closed forging is less than a volume of the preliminary formed body, a material of the residual preliminary formed body during a forging process may be pushed out of the mold in a flash form. That is, the flash is a residual portion of the preliminary formed body, which may be pushed out into a semi-closed space between the upper mold and the lower mold. Subsequently, the metal flow that is a fibrous tissue and the like may be formed in the forged part that is subjected to forging while the flash 20 is formed. Consequently, strength and buckling properties and the like of the forged part may be improved.

In certain exemplary embodiments, in the fourth step, when the forged part that is subjected to forging is cooled to normal temperature, a cooling speed may be in a range of about 0.8 to about 1.2° C./s. When the cooling speed is less than about 0.8° C./s, productivity may be reduced due to an excessive reduction in cooling speed. When the cooling speed is greater than 1.2° C./s, brittleness and the like of the forged part may increase due to rapid cooling.

In yet certain exemplary embodiments, in the fifth step, the punching process removing the flash may be performed in a cold state. In addition, an average density of the formed body formed in the first step may be in a range of about 6.3 to 6.9, and an average density of the forged part that is subjected to forging in the third step may be in a range of about 7.75 to 7.82. Further, during the short blast treatment of the sixth step, surface roughness of the forged part suitably may be e.g. from 10 μm to 60 μm such as about 30 μm.

Meanwhile, since in the first step, the preliminary formed body having a shape and a size that are similar to those of the connecting rod that is the final product is formed by using the metal powder and the like, the amount of the flash generated during semi-closed forging of the second step may be reduced e.g. by up to 20%, 30%, 40%, 50% or about 55% or more as compared to the amount of the flash generated through the hot forging process in the related art, and thus manufacturing cost may be saved for the reduced amount of the flash.

When the connecting rod is manufactured by applying the sinter forging process in the related art, the required punch number of a forming mold of the precise forming press may be about four at an upper end thereof and four at a lower end thereof, and a total of eight punches are required. However, the press for forming the preliminary formed body according to exemplary embodiments of the present invention, the punch number of the forming mold required may be about two at the upper end thereof and about three at the lower end thereof, and a total of five punches may be required. Accordingly, maintenance and management cost of the press may be reduced. Through a reduction in punch number of the forming mold, simplification of the shape of the preliminary formed body and optimization of a volume thereof may also be achieved, and an increase in metal flow may be induced through subsequently performed hot forging.

Moreover, since in the second step, semi-closed forging may be applied like the hot forging process where the forged part is manufactured by using hot forging, the metal flow that is the fibrous tissue formed by allowing crystalline particles in the connecting rod manufactured according to exemplary embodiments of the present invention to slide in a predetermined direction may increase, and the increased metal flow may improve strength and buckling properties and the like of the connecting rod.

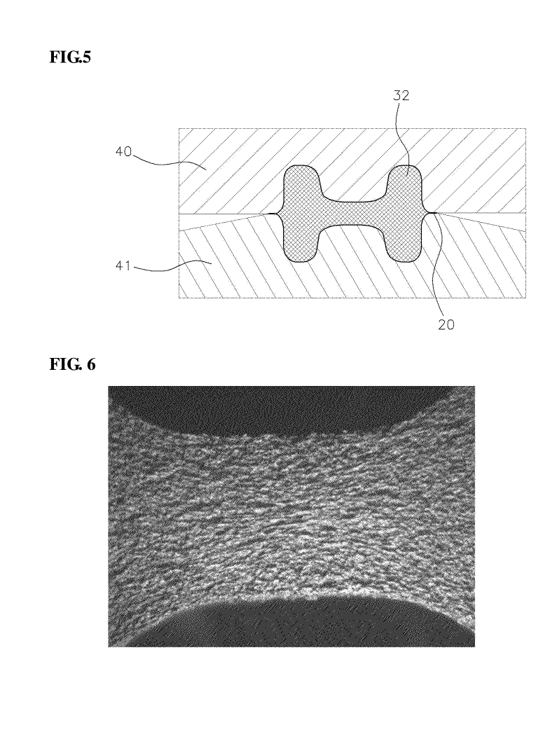

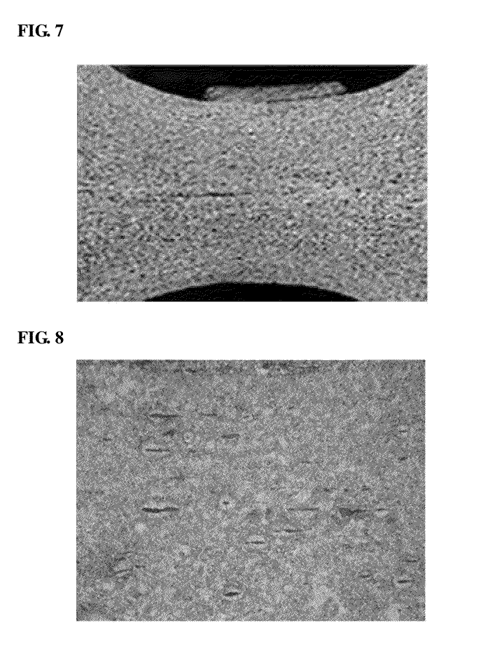

FIG. 6 is a photographic view showing the metal flow at an I cross-sectional portion of the connecting rod manufactured by using semi-closed sinter forging according to an exemplary embodiment of the present invention. FIG. 7 show a photographic view of a metal flow at the I cross-sectional portion of an exemplary connecting rod manufactured by using hot forging in the related art. As shown in FIGS. 6 and 7, the metal flow of the connecting rod manufactured by using semi-closed sinter forging according to exemplary embodiments of the present invention may be similar to the metal flow formed in the connecting rod manufactured by using hot forging in the related art, and as described above. In addition, physical properties such as tensile strength and yield strength of the manufactured connecting rod may be improved due to the metal flow formed by applying the semi-closed sinter forging process.

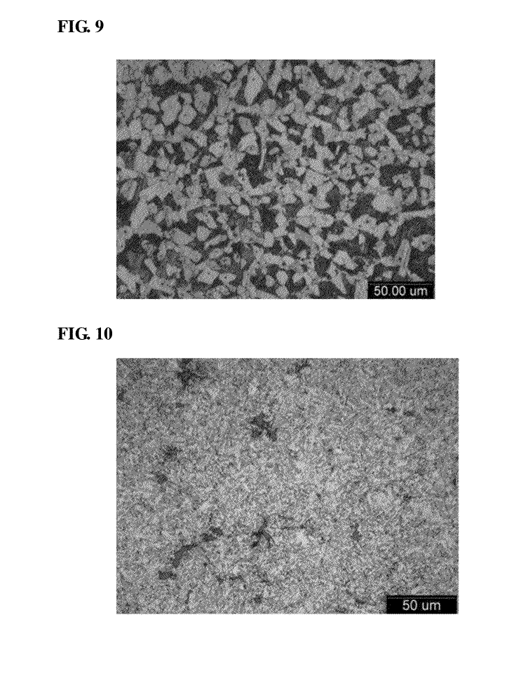

FIG. 8 is a microscopic view of a microtissue of an exemplary connecting rod manufactured by using semi-closed sinter forging according to an exemplary embodiment of the present invention; FIG. 9 is a microscopic view of a microtissue of an exemplary connecting rod manufactured by using hot forging in the related art; and FIG. 10 is a microscopic view of a microtissue of an exemplary connecting rod manufactured by using sinter forging in the related art. As shown in FIGS. 8, 9, and 10, the microtissue of the connecting rod manufactured by using semi-closed sinter forging according to an exemplary embodiment of the present invention may be as fine as the connecting rod manufactured by using hot forging in the related art, and bainite that is a black acicular reinforcing tissue may be included in the connecting rod in an exemplary embodiment of the present invention like in the connecting rod manufactured by using sinter forging in the related art.

In other aspect, the method of manufacturing the connecting rod according to various exemplary embodiments of the present invention may be applied to a method of manufacturing a connecting rod which requires excellent strength and buckling properties and the like.

### Example

Hereinafter, the present invention will be described in more detail through the Examples. These Examples are only for illustrating the present invention, and it will be obvious to those skilled in the art that the scope of the present invention is not interpreted to be limited by these Examples.

Yield strengths and tensile strengths of Examples manufactured according to the method of manufacturing the connecting rod by using semi-closed sinter forging according various exemplary embodiments of the present invention are compared to yield strengths and tensile strengths of Comparative Examples manufactured by using sinter forging in the related art.

TABLE 1

| | | Yield | Tensile |
|---|---|---|---|
| Classification | Unit | strength | strength |
| Example 1 | MPa | 805 | 1032 |
| Example 2 | MPa | 810 | 1048 |
| Example 3 | MPa | 788 | 1047 |
| Example 4 | MPa | 773 | 1055 |
| Example 5 | MPa | 793 | 1035 |
| Comparative Example 1 | MPa | 703 | 935 |
| Comparative Example 2 | MPa | 710 | 954 |
| Comparative Example 3 | MPa | 721 | 941 |
| Comparative Example 4 | MPa | 715 | 939 |
| Comparative Example 5 | MPa | 719 | 951 |

In Table 1, yield strengths and tensile strengths of Examples 1 to 5 repeatedly manufactured under the same condition according to exemplary embodiments of the present invention and Comparative Examples 1 to 5 repeatedly manufactured according to the sinter forging process in the related art are shown and compared.

In detail, the average of yield strengths of Examples 1 to 5 of Table 1 was about 793.8 MPa which was improved by about 11% as compared to about 713.6 MPa that was the average of yield strengths of Comparative Examples 1 to 5. Moreover, the average of tensile strengths of Examples 1 to 5 was about 1,043.4 MPa which was improved by about 10% as compared to about 944 MPa that was the average of tensile strengths of Comparative Examples 1 to 5.

TABLE 2

| | Comparative | Comparative | |
|---|---|---|---|
| Classification | Example 6 | Example 7 | Example 1 |
| Weight of raw material | 100 kg | 43.3 kg | 45 kg |
| Weight of final forged part | 35.2 kg | 36.2 kg | 36 kg |
| Loss weight | 64.8 kg | 7.1 kg | 9 kg |
| Relative Production cost | 1 | 0.89 | 0.85 |

In Table 2, shown and compared are the weights of the added raw materials, the weights of the final forged parts, and production cost of Comparative Example 6 to which the hot forging process is applied, Comparative Example 7 to which the sinter forging process is applied, and Example 1 to which the semi-closed sinter forging process according to an exemplary embodiment of the present invention is applied.

In the case of Example 1, the weight of the added raw material was about 45 kg and the weight of the produced final forged part was about 36 kg, and thus the loss weight was about 9 kg, and the loss weight value was significantly less than that of Comparative Example 6 to which the hot forging process was applied, but was slightly greater than that of Comparative Example 7 to which the sinter forging process was applied. However, if production cost of Comparative Example 6 was set as 1, production cost of Comparative Example 7 was about 0.89 and production cost of Example 1 was about 0.85 which may cost the lowest. Accordingly, the loss weight of Example 1 was slightly greater than that of Comparative Example 7, and total production cost of Example 1 was lowest.

As described above, the production cost of the semi-closed sinter forging process according to the present invention, may be reduced, because a laser notch process, a small end portion drill process, a coining process, a residual stress heat treatment process, an inner diameter rough-machining process of a big end portion, and the like are not included unlike the hot forging process and further because low-priced general press forming may be applied instead of costly precise press forming unlike the sinter forging process.

Accordingly, the method of manufacturing the connecting rod by using semi-closed sinter forging according to various exemplary embodiments of the present invention, as compared to the hot forging process or the sinter forging process used in the related art, manufacturing cost may be reduced, and the same metal flow as that of the connecting rod manufactured by using hot forging may be ensured, and thus mechanical properties such as yield strength and tensile strength of the connecting rod as of the final forged part may be improved.

As described above, the present invention has been described in relation to exemplary embodiments of the present invention, but the embodiments are only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A method of manufacturing a connecting rod by using semi-closed sinter forging, comprising steps of:
a first step of positioning a metal powder of a sintering material in a closed mold and then forming a preliminary formed body by using a general forming press;
a second step of heating the formed preliminary formed body to sinter the preliminary formed body;
a third step of semi-closed forging the sintered preliminary formed body to manufacture a forged part;
a fourth step of cooling the manufactured forged part to normal temperature;
a fifth step of removing a flash from the cooled forged part through a punching process; and
a sixth step of manufacturing the connecting rod through a shot blast treatment in order to remove a foreign substance existing on a surface of the forged part from which the flash is removed.

2. The method of claim 1, wherein in the second step, a sintering temperature is in a range of about 1100 to about 1250° C.

3. The method of claim 2, wherein a present sintering time is for about 10 to about 30 minutes at the sintering temperature.

4. The method of claim 1, wherein in the second step, an atmosphere during sintering includes nitrogen gas (N₂) and hydrogen gas (H₂), and a volume ratio of nitrogen gas (N₂) and hydrogen gas (H₂) is about 90:10.

5. The method of claim 1, wherein in the third step, an average thickness of the flash formed around the forged part is in a range of about 0.3 to about 0.5 mm.

6. The method of claim 1, wherein in the fourth step, when the forged part that is subjected to forging is cooled to normal temperature, a cooling speed is in a range of about 0.8 to about 1.2° C./s.

7. The method of claim 1, wherein during the short blast treatment of the sixth step, surface roughness of the forged part is about 30 μm.

8. The method of claim 1, wherein the preliminary formed body is formed by using a forming mold having two punches at an upper end and three punches at a lower end.

9. A connecting rod for a vehicle manufactured by the method of claim 1.
